(19) United States
(12) Patent Application Publication
(10) Pub. No.: US 2006/0235917 A1
(43) Pub. Date: Oct. 19, 2006

(54) Systems and methods for generating random numbers from astronomical events

(75) Inventor: Jeffrey Manber, Alexandria, VA (US)

Correspondence Address: LUCAS & MERCANTI, LLP, 475 PARK AVENUE SOUTH, 15TH FLOOR, NEW YORK, NY, 10016, US

(73) Assignee: VG GAMES LTD, London (GB)

(21) Appl. No.: 10/554,156

(22) PCT Filed: Apr. 20, 2004
(86) PCT No.: PCT/US04/12552

§ 371 Date: Oct. 20, 2005

Related U.S. Application Data
(60) Provisional application No. 60/464,409, filed on Apr. 21, 2003.

(51) Int. Cl. G06F 7/58

(52) U.S. Cl. 708/250

(57) ABSTRACT

The invention discloses systems and methods for generating pure random numbers from astronomical events, such as cosmic radiation or solar events. The invention includes a detector, a logic circuit, memory, power supply and a communication device. The detector may be, for example, a solar wind particle detector, an alpha ray detector, a gamma ray etector, or the like. The memory stores data from the detector. The communication device transmits the data. In addition, the logic circuit applies predetermined mathematical rules to the collected data to generate pure random numbers suitable for use in games of chance, horoscopes, astrology, sound or light displays, or other activities. In addition, the logic circuit may encrypt these random numbers before the numbers are transmitted to a receiving device.

### CROSS REFERENCE TO RELATED APPLICATION

This application claims priority from prior copending U.S. provisional patent application No. 60/464,409, filed Apr. 21, 2003. Such application is incorporated herein by reference.

### BACKGROUND OF THE INVENTION

A. Field of the Invention

The present invention relates to a random number generator and, more specifically, to mechanisms and methods for creating random numbers and other data from astronomical events.

B. Description of the Related Art

It has been observed that randomness and random data have traditionally been used for a variety of purposes, for example games of chance such as dice games. Such random data often takes the form of random numbers, letters, symbols or other variables such as, but not limited to, light and sound.

With the advent of computers, people recognized the need for a means of introducing randomness into a computer program. Surprising as it may seem, however, it is difficult to get a computer to do something by chance. A computer running a program follows its instructions blindly and is therefore completely predictable. Software is available today that generates “pseudo” random numbers. Although the numbers “look” random, they are not truly random because deterministic rules are used by the software.

True random numbers are typically generated by sampling and processing a source of entropy outside the computer. True random numbers may also be generated by hardware within the computer if a source of internal entropy is available. A source of entropy can be very simple, such as variations in mouse movements or in the amount of time between keystrokes. In practice, however, it can be tricky to use user input as a source of entropy. Keystrokes, for example, are often buffered by the computer's operating system, meaning that several keystrokes are collected before they are sent to the program waiting for them. To the program, it will seem as though the keys were pressed almost simultaneously.

A good source of entropy is a radioactive source. The points in time at which a radioactive source decays are completely unpredictable, and can be sampled and fed into a computer, avoiding any buffering mechanisms in the operating system. Other sources of entropy can be radio noise, thermal noise, background acoustic noise from an office or laboratory, or “hits” on a Web site.

The quality of “randomness” can be measured in a variety of ways. One common method is to compute the information density, or entropy, in a series of numbers. The higher the entropy in a series of numbers is, the more difficult it is to predict a given number on the basis of the preceding numbers in the series. A sequence of good random numbers will have a high level of entropy, although a high level of entropy does not guarantee randomness. (As an example, a computer file compressed with a commercial software file compression program often has a high level of entropy, but the data is highly structured and therefore not random.) Hence, for a thorough test of a random number generator, computing the level of entropy in the numbers alone is not enough. The artisan will find more detail at http://www.random.org/essay.html

A number of methods to generate random numbers are disclosed in the prior art. See, for example, U.S. Pat. Nos. 6,542,014; 6,393,448; and 6,435,501.

Off-site random number generators have unique requirements. As used herein, the term “off-site” means any random number generator in which a potential user of the random number could not physically witness the act of number generation.

In the gaming industry, lotteries in some states and countries, such as lotto or raffles, are often drawn using a physical device such as a container containing numbered balls from which balls are drawn (hopefully) at random. Some lottery commissions are moving towards using computer-based systems to simulate the container containing numbered balls. One such example is in New Zealand.

The rapidly developing market known as “Internet gaming” relies on use of random number generators to produce the winning results of each and every game opportunity. Two types of random number generators are used: those that produce what are called “true” random numbers, which are streams of data produced by hardware devices dedicated to random number generation; and those that produce what are called “pseudo” random numbers through the use of software designed for this purpose.

Some in the gaming and lottery industries have suggested that there should be four requirements for a computer-based draw: (1) The probability of the set of numbers drawn by the computer should be the same as those that they would have using numbered balls drawn perfectly randomly from a container; (2) No one (including the programmer or person certifying the method) should be able to predict the numbers to be drawn; (3) No one should be able to influence the outcome of the draw to his or her advantage; and (4) Some qualified person must be able to certify that the first three conditions are satisfied, as summarized by Robert Davies at http://www.robertnz.net/true_rng.html

For an off-site random number generator suitable for gaming, the following additional requirements should also be satisfied: (5) A potential player should be able to understand how the random number generator works; (6) A potential player should perceive the random number generator to be fair; and (7) It should be novel.

Certain random number generators based on photon detection, such as that shown in U.S. Pat. No. 6,539,410, and certain random number generators based on turbulent convection, such as that shown in U.S. Patent Publication No. 2001/0046293, are known in the art. It would, however be extraordinarily difficult to explain to a potential game player how these systems work. It is not enough that a random number generator suitable for gaming be “fair” according to points 1-4 of the above discussion. A potential player must perceive it as fair.

Accordingly, there is a need in the art for novel systems and methods to generate pure random numbers or other random data that satisfy the aforementioned requirements and avoid the limitations of the prior art.

### SUMMARY OF THE INVENTION

Systems and methods consistent with the principles of this invention address these and other needs by providing for a novel random number generator. The present invention is novel in that, among other things, it generates a flow of pure random numbers from the very forces of outer space. The present invention provides a direct connection to forces of nature incorporating random off-site events in a manner that is transparent and novel.

In one embodiment, the invention is directed to a device for detecting signals from astronomical events such as cosmic radiation, for the purpose of generating random numbers. The random numbers are suitable for use in a wide variety of applications, such as games of chance, horoscopes, astrology, sound and light displays, etc. The device includes a cosmic ray detector, a logic circuit with memory, a power supply and a communication device. A control circuit is configured to record raw data from the detector and at predetermined intervals transmit this data, or processed data derived from the raw data, through the communication device to a receiving device such as a gaming device. The device is able to operate both in an airless environment, such as on a satellite or in a life sustaining environment such as that on a manned space station, and also on Earth.

In another embodiment, the invention comprises a method that applies mathematical or other algorithmic rules to the collected data for the purposes of generating a random number. Additionally, the method may include means to encrypt the random number generated.

Another embodiment of the invention is directed to a device with multiple detectors.

Yet another embodiment of the invention is directed to a device with a means to orient itself, and remain oriented, towards a source of astronomical events.

More particularly, the invention comprises a random data generator comprising:

(a) means for detecting signals from astronomical events;

(b) means for calculating random data from said signals; and

(c) means for storing said random data.

In another embodiment, the invention comprises a random number generator comprising:

(a) means for detecting signals from astronomical events;

(b) means for calculating random numbers from said signals;

(c) means for storing said random numbers; and

(d) means for distributing said random numbers to receiving means.

In another embodiment, the invention comprises a random number generator having a processor operating under software control for processing astronomical signals to generate pure random numbers using mathematical rules, the rules comprising computations of standard deviations of pulses representing data from the signals.

In another embodiment, the invention comprises a method for generating random data, comprising the steps of:

(a) collecting entropy by detecting signals from astronomical events;

(b) generating random data from the signals using mathematical rules;

(c ) storing the random data;

(d) performing digital unbiasing on the random data; and

(e) creating and storing a random data pool from the unbiased random data.

In another embodiment, the invention comprises a method for generating random numbers, comprising the steps of:

(a) collecting entropy by detecting signals from astronomical events;

(b) storing the signals;

(c) generating random numbers from the signals using mathematical rules;

(d) storing the random numbers;

(e) performing digital unbiasing on the random numbers;

(f) creating and storing a random number pool from the unbiased random numbers; and

(g) distributing numbers from the random number pool to users.

In another embodiment, the invention comprises a method for generating random numbers using mathematical rules, including the steps of:

(a) storing a series of pulses received from a detector, each pulse representing raw astronomical data from the detector received over a period of time, the number of pulses being statistically significant; and

(b) performing statistical deviation calculations on each pulse, as follows:
(1) if the pulse is equal or greater than one positive standard deviation, it is considered a “1”;
(2) if the pulse is equal or greater than one negative standard deviation, it is considered a “0”; and
(3) if the pulse is between negative one standard deviation and one positive deviation, it is considered a null.

In another embodiment, the invention comprises a method of improving the randomness of games of chance by providing access to pure random numbers generated from astronomical events, comprising:

(a) detecting signals from astronomical events;

(b) generating random numbers from the signals using mathematical rules;

(c) storing the random numbers;

(d) processing the random numbers to eliminate bias; and

(e) distributing the processed random numbers to operators of games of chance.

In another embodiment, the invention comprises a method for generating random data, comprising:

(a) detecting signals from space phenomena using dedicated sensors located in space;

(b) transmitting the signals to a base station on Earth;

(c) storing the signals;

(d) applying procedures to the signals to generate random data; and

(e) transmitting the random data to one or more end users.

In another embodiment, the invention comprises a method for generating random data, comprising:

(a) receiving signals from space phenomena using dedicated sensors located on Earth;

(b) transmitting the signals to a base station;

(c) storing the signals;

(d) applying procedures to the signals to generate random data; and

(e) transmitting the random data to one or more end users.

In another embodiment, the invention comprises a method for generating random data, comprising:

(a) receiving signals from space phenomena at an existing Earth-based collection facility;

(b) transmitting the signals to a base station;

(c) storing the signals;

(d) applying procedures to the signals to generate random data; and

(e) transmitting the random data to one or more end users.

In another embodiment, the invention comprises a method for generating random data, comprising:

(a) detecting signals from events that are influenced by space phenomena;

(b) transmitting the signals to a base station;

(c) storing the signals at the base station;

(d) applying procedures to the signals to generate random data; and

(e) transmitting the random data to one or more end users.

In another embodiment, the invention comprises a method for generating a periodic flow of random numbers, comprising:

(a) detecting signals from extra-terrestrial sources for use as seeds;

(b) transmitting the seeds to a base station;

(c) storing the seeds;

(d) applying algorithmic calculations to the seeds to generate random numbers; and

(e) transmitting the random numbers to one or more end users.

In another embodiment, the invention comprises a method for generating a continuous flow of random numbers, comprising:

(a) detecting signals from extra-terrestrial events;

(b) transmitting the signals continuously to a base station;

(c) generating a continuous flow of random numbers from the signals; and

(d) transmitting the random numbers continuously to one or more end users.

### BRIEF DESCRIPTION OF THE DRAWINGS

The accompanying drawings, which are incorporated in and constitute a part of this specification, illustrate the invention and, together with the description, explain the invention. In the drawings:

FIG. 1 is a block diagram showing an embodiment of the invention;

FIG. 2 is a block diagram showing another embodiment of the invention;

FIG. 3 is a block diagram of detector grid 210 of FIG. 2; and

FIG. 4 is a high level schematic diagram showing a process flow for one embodiment of the invention.

### DETAILED DESCRIPTION OF THE INVENTION

Definitions

For purposes of this application, and in order to more fully appreciate the scope and nature of the invention, the following terms are defined:

“Random number” means not only a conventional number such as “0”, “1”, “2”, etc., presented in a random order or at a random time, but also any random letter, symbol or signal capable of being displayed or capable of controlling a process.

“Entropy” means a measure of the disorder or randomness of a closed system.

“Astronomical event” means any event that in some way is generated from or influenced by the forces or bodies of outer space.

“User” means a player in a game of chance, someone involved in horoscopes or astrology, or someone involved in creating an environment via light or sound, where changing design features are influenced by the forces of space in the manner described in this invention.

“Off-site” means any random number generator in which a potential user of the random number could not physically witness the act of number generation.

Random Data Detection and Collection

The generation of pure random numbers and data requires a source of pure random raw data, or entropy, that is external to a random number generator. In one embodiment, the present invention uses a space-based data stream from current satellites that are now whirling through the universe. Some are detecting and measuring the temperature of outer space; some the magnetic and solar winds, some the Northern light ions, some the disturbances of the sun and the composition of the rings of Saturn, to name a few examples.

All of this data is currently being relayed through existing sensors and downlinked to earth stations. It is a steady stream of data.

In one embodiment, the invention randomly taps into different data streams several times a minute to prevent concerns that the data streams could be tampered with.

In another embodiment, the invention relies solely on a single data stream that may be encrypted.

In another embodiment, the space-based random data stream is offset or “mixed” with another random data stream (such as from a commercially-available random number generator chip) in order to generate a unique set of numbers (thus making the impact of any tampering meaningless from a statistical point of view)

The random numbers or data streams may be transmitted either from space on a satellite or space station or high-attitude balloon, or other moving platform or from a ground-based telescope or other instrument. Random numbers may be received at a receiver located at a cellular telephone tower or other facility, if necessary, for further processing and further distribution to gaming operators or end users.

Random Number Generation

In order to produce true random numbers from a computer-based algorithmic process, a source of entropy that is external to the random number generator machine is required. This is essential in order to prevent derivation of the “seed” process and prediction of the number sequence using brute force decryption techniques. In the present invention, the source of entropy is derived from extra-terrestrial sources.

In order to achieve the quality required for true random number generation, the present invention includes the following embodiments: (1) A lightweight high performance option that uses traditional seeding techniques and algorithmic calculations, but in which the seeding process is sourced directly from non-predicable extra-terrestrial sources; and (2) A non-algorithmic, hardware based, generation option that uses extra-terrestrial events such as light and sound to create a continuous flow of random numbers.

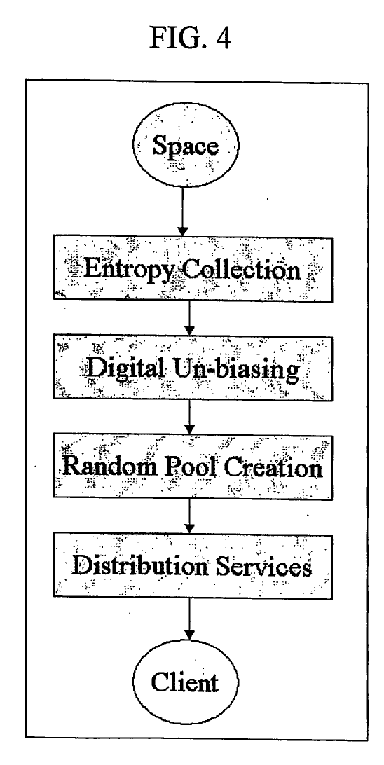

In either case, the same high level process flow structure is used for random number creation. The basic steps in this process are shown in FIG. 4. The steps are: (1) entropy collection; (2) digital unbiasing; (3) random pool creation; and (4) random number distribution.

Entropy Collection

In the first step, the invention uses electromagnetic signals such as light or radio waves as a chaotic source of bit generation. Both radio waves and light, originating from space, are used to drive dedicated hardware linked to a closed and encrypted collection of machine links. Possible sources include but are not limited to cosmic rays, solar wind events, solar flares, gravitational events and influences, disturbances outside the solar system, and other astronomical events and influences. During use, the actual source of this information, at any point in time, will possibly remain a secret to the user to ensure that its integrity is secured Firstly, the chaotic data source (such as signals from astronomical events) creates a sequence of binary digits generated by a detector. These are either a one (1) or a zero (0) in a continuous stream. Due to a tendency for this stream to become biased in either direction (i.e. 1 or 0) a process referred to as de-skewing is required.

Digital Un-Biasing

In another feature of the invention, procedures are applied to remove bias and assure randomness in the data. Using an accepted process of de-skewing, any digital bias will be removed. The following is one possible overview of this process. One skilled in the art will understand that there are different means to accomplish de-skewing.

Assuming an original random number output of:

Assuming an original random number output of:

01101110010111011110001001101010111100110111111000010001

This is first split into sequences of 2 bits:

01 10 11 10 01 01 11 01 11 10 00 10 01 10 10 10 11 11 00 11 01 11 11
10 00 01 00 01

Next, the repeating sequences of 00 and 11 are thrown out:

01 10 _ 10 01 01 _ 01 _ 10 _ 10 01 10 10 10 _{—} _{—} _{—} _ 01 _{—} _{—}
10 _ 01 _ 01

Finally, 01 is replaced by 0 and 10 by 1 giving the final string:

0 1 1 0 0 0 1 1 0 1 1 1 0 1 0 0

its use by client services. A continuous process of assessment now takes place to ensure the quality of the numbers being generated. These assessments form a part of the service level quality checks and drive a feedback loop to the original source of entropy. This can have the effect of switching sources on a continual basis.

Distribution

Having corrected the skewing anomaly, the data is then cached in a pool of numbers prior to distribution through a series of service layers.

A number of services are provided for distribution of the random numbers to clients such as casinos, horoscope providers and others. These include Internet Web services; FTP collections and XML-based facilities.

It should be noted that the distribution of the random numbers need not be delivered “live.” For example, in one embodiment, the random numbers may be delivered on a delayed basis, or stored for future use, for example in the selection of winning numbers for “scratch cards.”

It should also be noted that, in another embodiment of the invention, no step of “distribution” of the random data is required at all. This arises when, for example, an end user has access to all elements of the system, including the astronomical events, a receiving means such as a telescope or satellite dish, and a location for assuring the randomness of the data, on-site.

Hardware Implementations

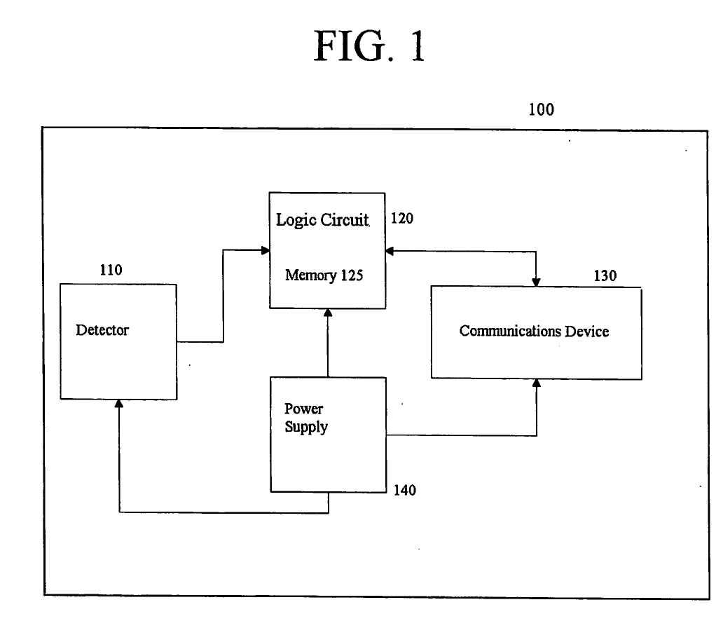

Referring now to FIG. 1, FIG. 1 shows a block diagram of an embodiment 100 of the invention. Preferably, a logic circuit or processor 120 including a memory 125 is connected to a detector 110 and a two-way communications device 130. Detector 110 is a detector for detecting electromagnetic or other signals generated by random astronomical events, such as cosmic rays, solar wind or eruptions, supernova explosions and other events. In another embodiment, detector 110 may also be adapted to detect turbulence in the Earth's atmosphere, or turbulence in ocean waves. Power supply 140 supplies necessary power to elements 110, 120 and 130. In this embodiment, memory 125 stores raw data from detector 110 for a predetermined period, then transmits this data wirelessly through communications device 130. A remote base station or other receiving device (not shown) receives this data, and then applies mathematical rules to convert the data to random numbers, for later display or other use. All functions of the invention are carried out under software control, the software preferably being stored in memory 125.

The random number generator described herein preferably is comprised of a plurality of “off the shelf” components that are capable of working in an airless environment, such as in a satellite, or in a life supporting environment of a space station, or on Earth. One skilled in the art will understand that there are multiple “off the shelf” components available to fulfill the various functions required for the current invention.

In an alternative embodiment, circuitry for converting the raw data into random numbers is mounted together with the detector, and the communications device transmits the random numbers themselves, but not the raw data unless instructed, to a remote receiver. In still another embodiment, the invention further includes an actual game of chance device, such as a keno machine, mounted together with the detector and conversion circuitry, and the communications device merely transmits the results of a game of chance played using the locally-generated random numbers as inputs.

An example that illustrates but does not limit the present invention is as follows. Detector 110 is turned on for “x” seconds and raw data is received and stored in the form of a “pulse.” The results are communicated to a base unit and stored. This pulse is repeated a statistically significant number of times. For the purposes of this discussion, it is assumed that the results form a standard bell curve. With this information in hand, the invention is able to apply mathematical rules to convert the raw data to random numbers, as follows:

Statistical deviation calculations are conducted on each pulse. The results of this calculation generate a table such as the one below to turn the pulse into a random number suitable for games of chance:
(a) If the pulse is equal or greater than one positive standard deviation, it is considered a “1”.
(b) If the pulse is equal or greater than one negative standard deviation, it is considered a “0”.
(c) If the pulse is between negative one standard deviation and one positive deviation, it is considered a null (a “do over”).

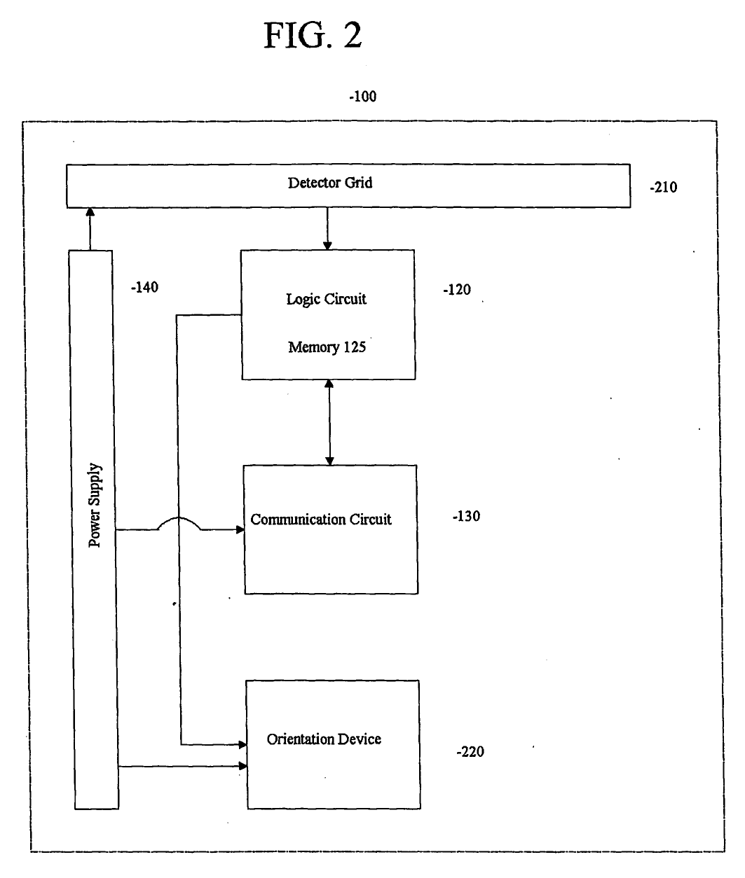

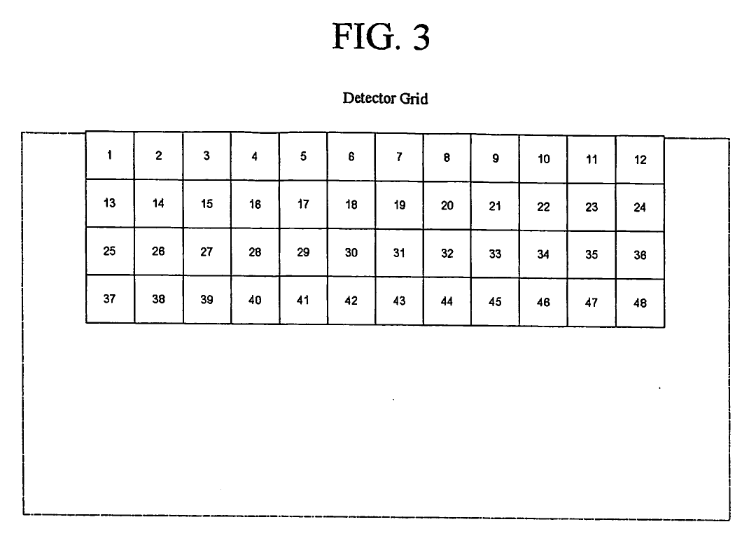

Reference is now made to FIG. 2, which is a block diagram showing another embodiment of the invention 100. This embodiment is designed for generating a random number suitable for “keno” type games. Detector grid 210 is comprised of discrete detection elements or areas. Referring to FIG. 3, an event detected by detection grid location 14 would not be detected by (or would be substantially weaker in) the detector grids around it, namely 1, 2, 3, 13, 15, 25, 26, and 27.

To ensure a generation of random numbers suitable for games of chance, detector grid 210 needs to be orientated in a specific manner for optimal results. For example, if the sun is used as a source of data from astronomical events such as solar eruptions, then the detector should be oriented toward the sun at all times to ensure an uninterrupted supply of data. Orientation device 220 keeps detector grid 210 positioned. Power supply 140 provides power to all components. Communication circuit 130 provides two-way communications between the device and a remote base station or other receiving device.

The following is another example is to illuminate, but not limit, the invention. In this embodiment, the detection device, associated circuitry and a gaming device are all deployed in space, such as on a satellite. Once in orbit, the following operations are carried out:
1. Self-test
2. Test results from detector grid
3. Start Game
4. End Game
5. Encrypt Game Results
6. Communicate Game Results
7. Encrypt and communicate test data, and raw data if instructed
8. Clear and Reset

The above steps are further described as follows:

Self-test. The first step is to ensure the device is working properly. Logic circuit 120 runs a diagnostic program before starting a new game. Any problems encountered are referred to the base station for analysis.

Test results from detector grid. The next step is to ensure the detector grid is in fact detecting a statistically random event. Enough data will be stored for statistical analysis. One positive standard deviation will be calculated and used to determine a threshold event (a “hit”).

Start game. For the purposes of this example, the game of chance involves picking six of the 48 possible numbers for the greatest return. That is, there can be no duplicate number. So when logic circuit 120 determines a threshold event has been met for one grid number, that number is recorded and not used again.

End game. When six numbers have been determined in this fashion, the game is ended.

Encrypt game results. In order to maintain security, the results are encrypted by logic circuit 120.

Communicate results. The six winning numbers are sent to a base station of the game's operator. In addition the results may be sent to a gaming commission or other controlling government agency and/or an uninterested third party to ensure fairness to the game's players.

Encrypt and communicate test data, and raw data if instructed. In order for the device owner to ensure the device is working properly, a processor under software control, or a hardware encryption module, is used to encrypt and communicate all data about a game, from the initial test data to the raw data of the actual game. In addition, a controlling government agency and/or an uninterested third party may require access to this information. If bandwidth is not an issue, this information could be communicated for each game. Assuming bandwidth is an issue, this information could be communicated by a predetermined table and/or on command.

Applications

The present invention is useful in numerous gaming and other situations. For example, the resulting product may be provided to existing casinos and to Bingo, Keno, Casino, Lottery and Internet gaming Web sites. In addition, the technology may also be provided to non-gaming markets, such as astrology and horoscope services, or any service that is based on providing a stream of data based on randomness generated from the forces of outer space. Also, computer games may be developed based on the invention.

A data center may encrypt the data and uplink it via their satellite network. It will then be fed into the Internet and sent directly to end users or others. End users may use the random numbers directly for their Internet gaming sites, lotteries, etc., or, feed the stream of space-based random numbers into the operator's own gaming commission-approved random number generators. In this case, data from the present invention will be the “seed” that feeds the “pod” of the approved random number generator (“RNG”).

In this manner, the present invention allows for the creation of unique and novel products of use to customers, whether casinos, Keno operators, Bingo parlors, internet gaming sites, lottery scratch cards, retail stores, horoscope internet sites, and others who use numbers, letters, light, sound and other forms of data generated from the forces of outer space.

While the invention has been described herein with reference to certain preferred embodiments, these embodiments have been presented by way of example only, and not to limit the scope of the invention. Numerous references have been cited herein, the disclosures of which are each incorporated by reference herein, in their entireties.

What is claimed is:

1. A random data generator comprising:
(a) means for detecting signals from astronomical events;
(b) means for calculating random data from said signals; and
(c) means for storing said random data.

2. A random number generator comprising:
(a) means for detecting signals from astronomical events;
(b) means for calculating random numbers from said signals;
(c) means for storing said random numbers; and
(d) means for distributing said random numbers to receiving means.

3. The random number generator of claim 2, in which the astronomical events comprise cosmic ray events, solar wind events or solar flare events.

4. The random number generator of claim 2, in which the means for detecting signals is an electromagnetic signal detector suitable for operation in space.

5. The random number generator of claim 2, in which the means for calculating the random numbers comprises a processor under software control for processing the signals using mathematical rules.

6. The random number generator of claim 5, in which the mathematical rules comprise computations of standard deviations of pulses representing data from the signals.

7. A method for generating random data, comprising:
(a) collecting entropy by detecting signals from astronomical events;
(b) generating random data from the signals using mathematical rules;
(c) storing the random data;
(d) performing digital unbiasing on the random data; and
(e) creating and storing a random data pool from the unbiased random data.

8. A method for generating random numbers, comprising:
(a) collecting entropy by detecting signals from astronomical events;
(b) storing the signals;
(c) generating random numbers from the signals using mathematical rules;
(d) storing the random numbers;
(e) performing digital unbiasing on the random numbers;
(f) creating and storing a random number pool from the unbiased random numbers; and
(g) distributing numbers from the random number pool to users.

9. The method of claim 8, in which the mathematical rules of step (c) comprise:
(a) storing a series of pulses received from a detector, each pulse representing raw data from the detector received over a period of time, the number of pulses being statistically significant; and
(b) performing statistical deviation calculations on each pulse, as follows:
(1) if the pulse is equal or greater than one positive standard deviation, it is considered a “1”;
(2) if the pulse is equal or greater than one negative standard deviation, it is considered a “0”; and
(3) if the pulse is between negative one standard deviation and one positive deviation, it is considered a null.

10. A method of improving the randomness of games of chance by providing access to pure random numbers generated from astronomical events, comprising:
(a) detecting signals from astronomical events;
(b) generating random numbers from the signals using mathematical rules;
(c) storing the random numbers;
(d) processing the random numbers to eliminate bias; and
(e) distributing the processed random numbers to operators of games of chance.

11. A method for generating random data, comprising:
(a) detecting signals from space phenomena using dedicated sensors located in space;
(b) transmitting the signals to a base station on Earth;
(c) storing the signals;
(d) applying procedures to the signals to generate random data; and
(e) transmitting the random data to one or more end users.

12. A method for generating random data, comprising:
(a) receiving signals from space phenomena using dedicated sensors located on Earth;
(b) transmitting the signals to a base station;
(c) storing the signals;
(d) applying procedures to the signals to generate random data; and
(e) transmitting the random data to one or more end users.

13. A method for generating random data, comprising:
(a) receiving signals from space phenomena at an existing Earth-based collection facility;
(b) transmitting the signals to a base station;
(c) storing the signals;
(d) applying procedures to the signals to generate random data; and
(e) transmitting the random data to one or more end users.

14. A method for generating random data, comprising:
(a) detecting signals from events that are influenced by space phenomena;
(b) transmitting the signals to a base station;
(c) storing the signals at the base station;
(d) applying procedures to the signals to generate random data; and
(e) transmitting the random data to one or more end users.

15. The method of claim 14, in which the events comprise ocean wave or cloud motions, and the space phenomena comprise gravitational or solar radiation influences.

16. A method for generating a periodic flow of random numbers, comprising:
(a) detecting signals from extra-terrestrial sources for use as seeds;
(b) transmitting the seeds to a base station;
(c) storing the seeds;
(d) applying algorithmic calculations to the seeds to generate random numbers; and
(e) transmitting the random numbers to one or more end users.

17. A method for generating a continuous flow of random numbers, comprising:
(a) detecting signals from extra-terrestrial events;
(b) transmitting the signals continuously to a base station;
(c) generating a continuous flow of random numbers from the signals; and
(d) transmitting the random numbers continuously to one or more end users.
